(19) United States
(12) Patent Application Publication
(10) Pub. No.: US 2016/0052793 A1
(43) Pub. Date: Feb. 25, 2016

(54) METHOD FOR SYNTHESIZING HYDROCYANIC ACID FROM FORMAMIDE - CATALYST

(71) Applicant: BASF SE, Ludwigshafen (DE)

(72) Inventors: RALF BÖHLING, Lorsch (DE); Michael SCHIPPER, Ludwigshafen (DE); Jens BERNNAT, Grünstadt (DE); Wilhelm WEBER, Neustadt (DE); Peter PETERSEN, Dannstadt-Schauernheim (DE); Anton NEGELE, Deidesheim (DE); Andreas DECKERS, Flomborn (DE)

(73) Assignee: BASF SE, Ludwigshafen (DE)

(21) Appl. No.: 14/783,314

(22) PCT Filed: Apr. 9, 2014
(86) PCT No.: PCT/EP2014/057112

§ 371 Date: Oct. 8, 2015

(30) Foreign Application Priority Data
Apr. 10, 2013 (EP) 13163130.1

(51) Int. Cl. C01C 3/02

(52) U.S. Cl. CPC C01C 3/0204

(57) ABSTRACT

Process for preparing hydrocyanic acid by thermolysis of gaseous formamide in a reactor in the presence of a catalyst, wherein
a) the catalyst is
(i) an aluminum oxide catalyst which comprises
   from 90 to 100% by weight, preferably from 99 to 100% by weight, of aluminum oxide as component A,
   from 0 to 10% by weight, preferably from 0 to 1% by weight, of silicon dioxide as component B and
   from 0 to not more than 0.1% by weight of iron or iron-comprising compounds as component C,
      where the total sum of the components A, B and C is 100% by weight, and has
(ii) a BET surface area, measured in accordance with DIN ISO 9277: 2003 May, of <1 m²/g and is
(iii) heat treated at temperatures of >1400° C. for from 1 to 30 hours, preferably ≧1500° C. for from 1 to 30 hours, particularly preferably at from 1500° C. to 1800° C. for from 2 to 10 hours, and
b) the reactor has an inner surface which is inert in respect of the thermolysis of formamide; and use of the catalyst in a process for preparing hydrocyanic acid by thermolysis of gaseous formamide in a reactor which has an inner surface which is inert in respect of the thermolysis of formamide

The present invention relates to a process for preparing hydrocyanic acid by thermolysis of gaseous formamide in the presence of an aluminum oxide catalyst having a BET surface area of <1 m²/g in a reactor which has an inner surface which is inert in respect of the thermolysis of formamide, and to the use of the aluminum oxide catalyst in a process for preparing hydrocyanic acid by thermolysis of gaseous formamide.

Hydrocyanic acid is an important basic chemical which serves as starting material in, for example, numerous organic syntheses such as the preparation of adiponitrile, methacrylic esters, methionine and complexing agents (NTA, EDTA). In addition, hydrocyanic acid is required for the preparation of alkali metal cyanides which are used in mining and in the metallurgical industry.

The largest amount of hydrocyanic acid is produced by reaction of methane (natural gas) and ammonia. In the Andrussov process, atmospheric oxygen is simultaneously introduced. In this way, the preparation of hydrocyanic acid proceeds autothermally. In contrast thereto, the BMA process of Degussa AG is carried out in the absence of oxygen. The endothermic catalytic reaction of methane with ammonia is therefore operated externally using a heating medium (methane or H₂) in the BMA process. A disadvantage of this process is the high unavoidable formation of ammonium sulfate since the reaction of methane can be carried out economically only when using an excess of NH₃. The unreacted ammonia is scrubbed out of the crude process gas by means of sulfuric acid.

A further important process for preparing HCN is the SOHIO process. In the ammonoxidation of propene/propane to form acrylonitrile, about 10% (based on propene/propane) of hydrocyanic acid is formed as by-product.

A further important process for the industrial preparation of hydrocyanic acid is thermal dehydration of formamide (thermolsis of formamide) under reduced pressure, which proceeds according to the equation (I):

HCONH₂→HCN+H₂O (I)

This reaction is accompanied by the decomposition of formamide according to equation (II) to form ammonia and carbon monoxide:

HCONH₂→NH₃+CO (II)

Ammonia is scrubbed out of the crude gas by means of sulfuric acid. However, due to the high selectivity, only very little ammonium sulfate is obtained.

Processes for preparing hydrocyanic acid by thermolysis of gaseous formamide in the presence of aluminum oxide catalysts are already known in the prior art.

Thus, DE 498 733 relates to a process for preparing hydrocyanic acid from formamide by catalytic dehydration, in which a water-withdrawing catalyst such as alumina, thorium oxide or zirconium oxide is used as catalyst, with the catalyst being ignited for a relatively long time until the activity has been significantly reduced before use. According to example 1, hydrocyanic acid is obtained in yields in the range from 30.6 to 91.5% when using heat-treated alumina. DE 498 733 gives no information about the inner surface of the tube reactor used. Furthermore, DE 498 733 gives no information about the selectivity of the catalyst used.

DE 199 62 418 A1 discloses a continuous process for preparing hydrocyanic acid by thermolysis of gaseous, superheated formamide at elevated temperature and under reduced pressure. The process is carried out in the presence of a finely divided solid catalyst in a thermolysis reactor, with the solid catalyst kept in motion by means of vertically upward-directed or vertically downward-directed flow of the gaseous reaction mixture. According to DE 199 62 418 A1, aluminum oxide or aluminum oxide/silicon dioxide catalysts are used as catalysts. DE 199 62 418 A1 gives no information on the material of the inner surface of the thermolysis reactor used. DE 199 62 418 A1 likewise gives no information about the selectivity of the process described in DE 199 62 418 A1.

EP 0 209 039 A2 relates to a process for the thermolytic dissociation of formamide to form hydrocyanic acid and water over shaped, highly sintered aluminum oxide or aluminum oxide-silicon dioxide bodies or over high-temperature-corrosion-resistant stainless steel packing elements in the simultaneous presence of atmospheric oxygen. According to EP 0 209 039 A2, stainless steel or iron tubes are used as reactors. According to examples 1 and 2 in EP 0 209 039 A2, highly sintered aluminosilicate is used as catalyst. A conversion of from 98 to 98.6% and a selectivity of from 95.9 to 96.7% are achieved in the thermolysis of formamide.

Owing to the relatively poor selectivity, the crude hydrocyanic acid gas mixture produced in the processes of the prior art comprises the components CO, NH₃ and CO₂ formed by secondary reactions and therefore has to be purified.

In view of the prior art, it is therefore an object of the present invention to avoid purification of the crude hydrocyanic acid gas mixture obtained by thermolysis of formamide and to use the crude hydrocyanic acid gas directly in subsequent steps. The direct use of the crude hydrocyanic acid gas obtained in subsequent steps enables the handling of liquid hydrocyanic acid, which in the presence of traces of basic components such as NH₃ tends to undergo explosive reactions, to be avoided.

The object is achieved by a process for preparing hydrocyanic acid by thermolysis of gaseous formamide in a reactor in the presence of a catalyst, wherein
a) the catalyst is
(i) an aluminum oxide catalyst which comprises
   from 90 to 100% by weight, preferably from 99 to 100% by weight, of aluminum oxide as component A,
   from 0 to 10% by weight, preferably from 0 to 1% by weight, of silicon dioxide as component B and
   from 0 to not more than 0.1% by weight of iron or iron-comprising compounds as component C,
      where the total sum of the components A, B and C is 100% by weight, and has
(ii) a BET surface area, measured in accordance with DIN ISO 9277: 2003 May, of <1 m²/g and is
(iii) heat treated at temperatures of >1400° C. for from 1 to 30 hours, preferably ≧1500° C. for from 1 to 30 hours, particularly preferably at from 1500° C. to 1800° C. for from 2 to 10 hours, and
b) the reactor has an inner surface which is inert in respect of the thermolysis of formamide.

It has been found according to the invention that it is not sufficient to use a selective aluminum oxide catalyst in order to achieve a high selectivity in the thermolysis of gaseous formamide to produce hydrocyanic acid. Simultaneously with the use of an aluminum oxide catalyst, it is necessary to avoid contact of the gaseous formamide with iron or iron-comprising materials/compounds since iron and iron-comprising materials/compounds have a significantly higher surface-specific activity in the thermolysis of gaseous formamide than aluminum oxide catalysts at significantly lower selectivity. This is the reason for the relatively low selectivities achieved hitherto in the prior art.

According to the present invention, contact of the gaseous formamide with iron or iron-comprising materials/compounds, e.g. steel, during the thermolysis of gaseous formamide is avoided. As a result, extraordinarily high hydrocyanic acid selectivities which make purification of the crude hydrocyanic acid gas obtained superfluous can be achieved.

For the purposes of the present invention, an inner surface of the reactor is the surface which is in direct contact with the reactants, i.e. with, inter alia, the gaseous formamide.

For the purposes of the present patent application, an inner surface of the reactor which is inert in respect of the thermolysis of formamide means that no decomposition of the formamide occurs at the reactor surface but instead the decomposition of formamide is catalyzed exclusively by the aluminum oxide catalyst used.

Suitable inner surfaces of the reactor which are inert in respect of the thermolysis of formamide are preferably selected from among silicon-coated steel surfaces and fused silica. Further suitable surfaces are, for example, titanium, SiC and zirconium.

As catalyst in the process of the invention, use is made of an aluminum oxide catalyst comprising
from 90 to 100% by weight, preferably from 99 to 100% by weight, of aluminum oxide as component A,
from 0 to 10% by weight, preferably from 0 to 1% by weight, of silicon dioxide as component B and
from 0 to not more than 0.1% by weight of iron or iron-comprising compounds as component C,
   where the total sum of the components A, B and C is 100% by weight.

The aluminum oxide catalyst used according to the invention has a BET surface area, measured in accordance with DIN ISO 9277: 2003 May, of <1 m²/g, preferably from 0.01 to 0.9 m²/g, particularly preferably from 0.02 to 0.3 m²/g.

The aluminum oxide catalyst used according to the invention can be obtained from commercially available catalysts (e.g. crushed aluminum oxide material from Feuerfest) by heat treatment of these catalysts at >1400° C. for from 1 to 30 hours, preferably ≧1500° C. for from 1 to 30 hours, particularly preferably at from 1500° C. to 1800° C. for from 2 to 10 hours, or can be produced by methods known to those skilled in the art.

The heat treatment of the aluminum oxide catalyst at >1400° C. for from 1 to 30 hours, preferably ≧1500° C. for from 1 to 30 hours, particularly preferably at from 1500° C. to 1800° C. for from 2 to 10 hours, is essential to achieve a high selectivity.

For example, the aluminum oxide catalyst used according to the invention can be produced by pressing freshly precipitated aluminum hydroxide or corresponding mixtures with silica gel after gentle drying to give the desired shaped bodies and subsequently heat-treating these at temperatures of >1400° C. for from 1 to 30 hours, preferably ≧1500° C. for from 1 to 30 hours, particularly preferably at from 1500° C. to 1800° C. for from 2 to 10 hours.

In the process of the invention, the catalyst is generally present in the form of shaped bodies selected from among ordered shaped bodies and disordered shaped bodies. Suitable shaped bodies are, for example, crushed material, Raschig rings, Pall rings, pellets, spheres and similar shaped bodies. Here, it is important that beds of the shaped bodies used allow good heat transfer with moderate pressure drops. The size and geometry of the shaped bodies used depend on the internal diameter of the reactor used.

Suitable sizes are, for example, average diameters of the shaped bodies, e.g. crushed material, of generally from 0.1 to 10 mm, preferably from 0.5 to 5 mm, particularly preferably from 0.7 to 3 mm.

The amount of catalyst used is generally from 2 to 0.1 kg, preferably from 1 to 0.2 kg, based on a continuous formamide flow of 1 kg per hour.

Reactors suitable for the thermolysis of gaseous formamide to produce hydrocyanic acid are known to those skilled in the art. Preferred suitable reactors for the thermolysis of gaseous formamide in order to produce hydrocyanic acid are tube reactors, particularly preferably multitube reactors, e.g. shell-and-tube apparatuses or similar apparatuses which introduce the heat of reaction over the entire reaction path. In addition, tray apparatuses or fluidized-bed apparatuses are also suitable; suitable tray apparatuses, fluidized-bed apparatuses and shell-and-tube apparatuses are known to those skilled in the art.

In the case of apparatuses, e.g. tube reactors, which introduce the heat of reaction over the entire reaction section, efficient heat transfer to the catalyst is advantageous in order to obtain high space-time yields.

The reaction channels of the reactor used, preferably tube reactor, generally have hydraulic diameters of from 0.5 mm to 100 mm, preferably from 1 mm to 50 mm, particularly preferably from 3 mm to 10 mm.

For the purposes of the present patent application, the hydraulic diameter is the average hydraulic diameter based in each case on a reaction channel of the reactor used according to the present patent application, preferably tube reactor. The hydraulic diameter dₕ is a theoretical parameter which can be used for carrying out calculations involving tubes or channels having a noncircular cross section. The hydraulic diameter is four times the flow cross section H divided by the circumference U wetted by fluid of a measurement cross section:

dₕ=4 A/U

The process of the invention makes it possible to attain high hydrocyanic acid selectivities in the thermolysis of formamide, with selectivities of >93%, preferably >96%, particularly preferably >98%, being achieved.

The abovementioned high selectivities can be achieved at low temperatures. At temperatures of from 350° C. to 400° C., it is possible to achieve, for example, hydrocyanic acid selectivities of generally >95%.

At the same time, good conversions of formamide are achieved, with the conversions generally being >88%, preferably >90%, particularly preferably >98%.

The thermolysis of gaseous formamide to produce hydrocyanic acid in the process of the invention is generally carried out at a temperature of from 350 to 700° C., preferably from 380 to 650° C., particularly preferably from 440 to 620° C. If higher temperatures above 700° C. are used, the selectivities deteriorate.

The pressure in the process of the invention is generally from 70 mbar to 5 bar, preferably from 100 mbar to 4 bar, particularly preferably from 300 mbar to 3 bar, very particularly preferably from 600 mbar to 1.5 bar, absolute pressure.

The thermolysis of gaseous formamide in the process of the invention is preferably carried out in the presence of oxygen, preferably atmospheric oxygen. The amounts of oxygen, preferably atmospheric oxygen, are generally from >0 to 10 mol %, based on the amount of formamide used, preferably from 0.1 to 9 mol %, particularly preferably from 0.5 to 3 mol %. As an alternative, a mode of operation without addition of oxygen is possible, e.g. with cyclic burning-off of the deposits formed in the thermolysis reactor.

The optimum space velocity over the catalyst in the process of the invention is determined by the desired degree of conversion and the size of the shaped bodies used. When crushed material (0.5-3 mm) is used, the space velocity over the catalyst at a target conversion of, for example, >90% is from about 1 to 2 g of formamide per g of catalyst per hour, at a temperature of 550° C.

The heating of the reactor used in the process of the invention is generally effected using hot burner offgases (circulation gas) or by means of a salt melt or direct electric heating. Apart from natural gas for heating the salt melt or circulation gas, it is additionally possible to use the tailgas formed in the hydrocyanic acid synthesis. This generally comprises CO, H₂, N₂ and small amounts of hydrocyanic acid.

### Production of the Gaseous Formamide

The gaseous formamide used in the process of the invention is obtained by vaporization of liquid formamide. Suitable processes for vaporizing liquid formamide are known to those skilled in the art and are described in the prior art mentioned in the introductory part of the description.

In general, vaporization of the formamide is carried out at a temperature of from 110 to 270° C. The vaporization of the liquid formamide is preferably carried out in a vaporizer at temperatures of from 140 to 250° C., particularly preferably from 200 to 230° C.

The vaporization of the formamide is generally carried out at a pressure of from 20 mbar to 3 bar. The vaporization of the liquid formamide is preferably carried out at an absolute pressure of from 80 mbar to 2 bar, particularly preferably from 600 mbar to 1.3 bar.

The vaporization of the liquid formamide is particularly preferably carried out at short residence times. Very particularly preferred residence times are <20 s, preferably <10 s, in each case based on the liquid formamide.

Owing to the very short residence times in the vaporizer, the formamide can be virtually completely vaporized without by-product formation.

The abovementioned short residence times of the formamide in the vaporizer are preferably achieved in millistructured or microstructured apparatuses. Suitable millistructured or microstructured apparatuses which can be used as vaporizer are described, for example, in DE-A-101 32 370, WO 2005/016512 and WO 2006/108796. A further method of vaporizing liquid formamide and also a suitable microvaporizer are described in WO 2009/062897. Furthermore, it is possible to carry out the vaporization of liquid formamide in a single-chamber vaporizer as described in WO 2011/089209.

In a preferred embodiment of the process of the invention, the gaseous formamide used is thus obtained by vaporization of liquid formamide at temperatures of from 100 to 300° C. using a millistructured or microstructured apparatus as vaporizer. Suitable millistructured or microstructured apparatuses are described in the abovementioned documents.

However, it is likewise possible to carry out the vaporization of the formamide in classical vaporizers.

### After-Reactor

An after-reactor can be installed downstream of the main reactor used for the thermolysis of formamide. In the after-reactor, which is filled with a catalytically active bed, the formamide conversion is increased up to ≧98% of the equilibrium conversion (complete formamide conversion), preferably ≧99%, particularly preferably ≧99.5% of the equilibrium conversion, generally without introduction of additional heat.

As catalytically active bed in the after-reactor, use is generally made of ordered packings made of steel or the above-described aluminum oxide catalysts.

The plate thickness of the internals is preferably >1 mm. Plates which are too thin become ductile and lose their stability as a result of the reaction conditions.

The use of static mixers in the after-reactor enables both a uniform pressure and excellent heat transfer to be achieved in the after-reactor.

Suitable static mixers are described, for example, in DE-A-101 38 553.

The steel in the ordered packings of the after-reactor, preferably the static mixers, particularly preferably the static mixers made of metal plates, is preferably selected from among steel grades corresponding to the standards 1.4541, 1.4571, 1.4573, 1.4580, 1.4401, 1.4404, 1.4435, 1.4816, 1.3401, 1.4876 and 1.4828, particularly preferably selected from among steel grades corresponding to the standards 1.4541, 1.4571, 1.4828, 1.3401, 1.4876 and 1.4762, very particularly preferably from among steel grades corresponding to the standards 1.4541, 1.4571, 1.4762 and 1.4828.

The gaseous reaction product obtained in the thermolysis of formamide is usually introduced at an entry temperature of from 450 to 700° C. into the after-reactor.

The after-reactor is usually operated at the pressure of the main reactor less the pressure drop therein. The pressure drop is, for example, 5-50 mbar.

Before introduction of the gaseous reaction product obtained after thermolysis of the gaseous formamide into the after-reactor, oxygen, preferably atmospheric oxygen, can optionally be introduced into the gaseous reaction product in order to avoid deposits on the ordered packings of the after-reactor. As an alternative, a mode of operation without addition of oxygen is possible, e.g. with cyclic burning-off of the deposits formed in the after-reactor.

In the case of the preferred use of an after-reactor, an even higher formamide conversion, preferably complete conversion, relative to the equilibrium conversion of formamide, can additionally be achieved. For this reason, condensation with high boiler formation and back-distillation of unreacted formamide can generally be dispensed with in the process of the invention.

The high hydrocyanic acid selectivity achieved by means of the process of the invention enables a complicated work-up of the crude hydrocyanic acid gas mixture to be avoided, and direct use of the crude hydrocyanic acid gas in subsequent steps is possible.

The crude hydrocyanic acid gas obtained after thermolysis of the formamide can thus usually be quenched directly in an NH₃ absorber or, if NH₃ does not interfere in the subsequent process, can be used directly for further processing, e.g. to prepare aqueous NaCN solution or aqueous CaCN₂ solution.

### Quenching of the Crude Hydrocyanic Acid Gas

The quenching of the hot crude gas stream comprising hydrocyanic acid gas which is obtained after the thermolysis of gaseous formamide is usually carried out by means of dilute acid, preferably by means of dilute H₂SO₄ solution. This is usually pumped in a circuit via a quenching column. Suitable quenching columns are known to those skilled in the art. At the same time, the NH₃ formed is bound to form ammonium sulfate. The heat (gas cooling, neutralization and dilution) is generally removed by means of a heat exchanger (usually cooling water) in a pumped circuit. At quenching temperatures of generally from about 10 to 65° C., water is condensed out at the same time and is generally discharged as dilute ammonium sulfate solution via the bottom and disposed of. The absorber temperature is laid down by the desired water content of the crude hydrocyanic acid gas. If a partial amount of the bottoms is vaporized, hydrocyanic acid dissolved in the bottoms can be removed. The bottom product can thus be used, for example, as fertilizer. An about 70-99% strength hydrocyanic acid gas stream leaves the quenching column at the top. This can additionally comprise CO, CO₂, water and H₂. If the quenching column is operated as a pure absorber, the dissolved hydrocyanic acid is usually stripped out in a separate desorber, preferably by means of steam. Suitable desorbers are known to those skilled in the art.

### Compressor

It is possible for the quenching column to be followed by a compressor which compresses the gas leaving the top of the quenching column to a pressure corresponding to a desired process for further processing of the hydrocyanic acid gas stream. This process for further processing can be, for example, a work-up to give pure hydrocyanic acid or any further reactions of the gas stream comprising hydrocyanic acid.

If any amounts of ammonia present and formamide residues do not interfere in the subsequent process in which the hydrocyanic acid gas stream obtained after thermolysis is to be used, the crude hydrocyanic acid gas obtained after thermolysis of the gaseous formamide can also be used directly, without a reaction gas quench or NH₃ absorber, in the subsequent steps (processes for further processing of the hydrocyanic acid gas stream).

### Use

The present invention further provides for the use of a catalyst which is
(i) an aluminum oxide catalyst which comprises
   from 90 to 100% by weight, preferably from 99 to 100% by weight, of aluminum oxide as component A,
   from 0 to 10% by weight, preferably from 0 to 1% by weight, of silicon dioxide as component B and
   from 0 to not more than 0,1% by weight of iron or iron-comprising compounds as component C,
      where the total sum of the components A, B and C is 100% by weight, and has
(ii) a BET surface area, measured in accordance with DIN ISO 9277: 2003 May, of <1 m²/g and is
(iii) heat treated at temperatures of >1400° C. for from 1 to 30 hours, preferably ≧1500° C. for from 1 to 30 hours, particularly preferably at from 1500° C. to 1800° C. for from 2 to 10 hours,
   in a process for preparing hydrocyanic acid by thermolysis of gaseous formamide in a reactor which has an inner surface which is inert in respect of the thermolysis of formamide.

Preferred catalysts, reactors and process conditions have been mentioned above. The following examples illustrate the invention.

### EXAMPLES 1 TO 6

The studies in examples 1 to 6 are carried out in a 17 cm long electrically heated fused silica reactor having an internal diameter of 17 mm and a reactor inlet pressure of about 130 mbar. The crushed material size is from about 1 to 2 mm.

### EXAMPLE 1 (COMPARISON)

Crushed quartz material, BET surface area 0.06 m²/g, amount of catalyst 100 g, formamide feed rate 29 g/h, air feed 21/h, throughput per unit surface area 4.8 g/m²h.

| Temperature | Conversion | Selectivity |
|---|---|---|
| 350 | 0.81 | 0 |
| 375 | 2.27 | 50 |
| 400 | 3.63 | 68.52 |
| 425 | 4.96 | 73.97 |
| 450 | 6.15 | 70.78 |

### EXAMPLE 2 (COMPARISON)

Crushed material derived from steatite balls from Ceramtec (64% of SiO₂, 29% of MgO, 4% of Al₂O₃, 2% of FeO+TiO₂), BET surface area 0.1 m²/g amount of catalyst 100 g, formamide feed rate 29 g/h, air feed 2 l/h, throughput per unit surface area 2.9 g/m²h.

| Temperature | Conversion | Selectivity |
|---|---|---|
| 350 | 1.38 | 55 |
| 400 | 5.44 | 80.49 |
| 450 | 23.08 | 88.75 |
| 500 | 62.78 | 91.49 |
| 530 | 94.69 | 93.09 |
| 550 | 98.57 | 92.73 |

### EXAMPLE 3 (INVENTION)

Crushed aluminum oxide material from Feuerfest, heat treated at 1600° C., BET surface area: 0.21 m²/g, amount of catalyst 191 g, formamide feed rate 29 g/h, air feed 21/h, throughput per unit surface area 0.7 g/m²h.

| Temperature | Conversion | Selectivity |
|---|---|---|
| 350 | 6.25 | 96.72 |
| 375 | 16.74 | 96.86 |
| 400 | 32.04 | 97.83 |
| 425 | 52.06 | 98.07 |
| 450 | 69.89 | 98.13 |
| 475 | 81.4 | 98.08 |
| 500 | 98.59 | 97.77 |

The catalysts used according to the prior art usually do not display an approximately constantly high selectivity behavior. However, a constant high selectivity behavior can be achieved by means of the catalysts used according to the invention.

### EXAMPLE 4 (COMPARISON)

Crushed aluminum oxide material, from Norton, BET surface area 3.1 m²/g, formamide feed rate 29 g/h, air feed 2 l/h, diluted 1:17 with crushed fused silica (mixed BET area 0.27 m²/g), amount of catalyst 135 g, throughput per unit surface area 1.2 g/m²h.

| Temperature | Conversion | Selectivity |
|---|---|---|
| 350 | 3.49 | 56.86 |
| 400 | 12.89 | 79.37 |
| 450 | 37.73 | 88.47 |
| 500 | 82.71 | 91.25 |
| 510 | 84.05 | 91.67 |
| 520 | 98.49 | 90.14 |

### EXAMPLE 5 (COMPARISON)

Crushed aluminum oxide material, from Norton, BET surface area 3.1 m²/g, formamide feed rate 29 g/h, air feed 2 l/h, diluted with crushed fused silica (mixed BET area 0.16 m²/g), amount of catalyst 148.5 g, throughput per unit surface area 1.9 g/m²h.

| Temperature | Conversion | Selectivity |
|---|---|---|
| 350 | 0.60 | 81.82 |
| 400 | 8.53 | 75.57 |
| 450 | 61.10 | 88.06 |
| 465 | 33.80 | 84.99 |
| 490 | 51.60 | 87.17 |
| 520 | 72.46 | 90.27 |
| 550 | 87.73 | 90.20 |

### EXAMPLE 6 (COMPARISON)

Fe—Al spinel, BET surface area 2 m²/g, formamide feed rate 29 g/h, air feed 2 l/h, diluted 1:11 with crushed fused silica (mixed BET area 0.19 m²/g), amount of crushed material 156 g, throughput per unit surface area 1.0 g/m²h.

| Temperature | Conversion | Selectivity |
|---|---|---|
| 350 | 16.04 | 76.29 |
| 375 | 30.36 | 77.9 |
| 400 | 47.66 | 78.28 |
| 425 | 70.82 | 79.3 |
| 450 | 90.18 | 80.31 |
| 475 | 98.31 | 84.36 |
| 500 | 98.37 | 85.34 |
| 525 | 99.41 | 83.53 |
| 550 | 98.84 | 58.24 |

### EXAMPLE 7 (COMPARISON)

The studies are carried out in a 20 cm long electrically heated empty stainless steel tube (1.4571). The internal diameter is 3 mm, the reactor inlet pressure is 1.1 bar abs, formamide feed rate 50 g/h, air 2.1 standard l/h, throughput per unit surface area 26 540 g/m²h.

| Temperature | Conversion | Selectivity |
|---|---|---|
| 545 | 82.54 | 93.27 |
| 565 | 87.32 | 93.58 |
| 590 | 88.89 | 93.75 |
| 625 | 90.68 | 93.66 |

### EXAMPLES 8 AND 9

The studies in examples 8 and 9 are carried out in a 20 cm long electrically heated stainless steel tube having a silicon coating from Silicotek. The internal diameter is 5.4 mm, the reactor inlet pressure is 1.1 bar abs and the crushed material size is from about 1 to 2 mm.

### EXAMPLE 8 (COMPARISON)

Crushed quartz material, BET surface area 0.06 m²/g, amount of catalyst 4.6 ml, formamide feed rate 40 g/h, air feed 1.7 standard 1/h, throughput per unit surface area 145 g/m²h.

| Temperature | Conversion | Selectivity |
|---|---|---|
| 300 | 2.03 | 10 |
| 460 | 2.8 | 43.3 |
| 490 | 3.9 | 62.07 |
| 520 | 5.6 | 73.17 |

### EXAMPLE 9 (INVENTION)

Crushed aluminum oxide material from Feuerfest, heat treated at 1600° C., BET surface area: 0.21 m²/g, amount of catalyst 3.5 g, formamide feed rate 40 g/h, air feed 1.7 standard 1/h, throughput per unit surface area 54 g/m²h.

| Temperature | Conversion | Selectivity |
|---|---|---|
| 300 | 8.94 | 17.39 |
| 460 | 55.26 | 91.42 |
| 490 | 75.41 | 96.08 |
| 520 | 88.6 | 98.58 |

### EXAMPLES 10 TO 12

The experiments are carried out in electrically heated tubes having the geometry 12 x 2 x 240 mm. Formamide feed rate: 50 g/h; air feed: 2.1 l/h; pressure: 280-300 mbar; crushed material size about 1-2 mm.

### EXAMPLE 10 (COMPARISON)

The study is carried out in an empty stainless steel tube (1.4571).

| Temperature | Conversion | Selectivity |
|---|---|---|
| 525 | 85.4 | 92.8 |
| 550 | 92.1 | 92.1 |

### EXAMPLE 11 (COMPARISON)

Tube coated with Si by Silicotek, filled with 20.3 g of crushed sintered α-alumina from Feuerfest, type: SK, BET surface area 0.06 m²/g (without after-calcination (heat treatment)).

| Temperature | Conversion | Selectivity |
|---|---|---|
| 525 | 94.5 | 95.4 |
| 550 | 99.0 | 93.9 |

### EXAMPLE 12 (INVENTION)

Tube coated with Si by Silicotek, 21.2 g of sintered α-alumina from Feuerfest, type: SK, after-calcined at 1600° C. for 4 hours, BET surface area 0.02 m²/g.

| Temperature | Conversion | Selectivity |
|---|---|---|
| 525 | 56.7 | 99.1 |
| 550 | 75.3 | 98.8 |
| 575 | 88.3 | 98.8 |
| 600 | 93.4 | 97.4 |

1.-12. (canceled)

13. A process for preparing hydrocyanic acid by thermolysis of gaseous formamide in a reactor in the presence of a catalyst, wherein
a) the catalyst is
(i) an aluminum oxide catalyst which comprises
from 90 to 100% by weight, of aluminum oxide as component A,
from 0 to 10% by weight, of silicon dioxide as component B and
from 0 to not more than 0.1% by weight of iron or iron-comprising compounds as component C,
where the total sum of the components A, B and C does not exceed 100% by weight, and has
(ii) a BET surface area, measured in accordance with DIN ISO 9277: 2003 May, of <1 m²/g and is
(iii) heat treated at temperatures of >1400° C. for from 1 to 30 hours, and
b) the reactor has an inner surface which is inert in respect of the thermolysis of formamide.

14. The process according to claim 13, wherein the total sum of the components A, B and C is 100% by weight.

15. The process according to claim 13, wherein the catalyst is present in the form of shaped bodies selected from among ordered shaped bodies and disordered shaped bodies.

16. The process according to claim 13, wherein the reactor is a tube reactor.

17. The process according to claim 16, wherein the tube reactor has an inner surface selected from among silicon-coated steel, fused silica, titanium, SiC and zirconium.

18. The process according to claim 13, wherein the thermolysis of gaseous formamide is carried out at a temperature of from 350 to 700° C.

19. The process according to claim 13, wherein the thermolysis of gaseous formamide is carried out at a pressure of from 70 mbar to 5 bar, absolute pressure.

20. The process according to claim 13, wherein the thermolysis of gaseous formamide is carried out in the presence of oxygen.

21. The process according to claim 13, wherein the gaseous formamide is obtained by vaporization of liquid formamide in a vaporizer at temperatures of from 110 to 270° C.

22. The process according to claim 21, wherein the vaporization of the formamide is carried out at a pressure of from 20 mbar to 3 bar.

23. The process according to claim 21, wherein the vaporization of the formamide is carried out at a residence time of the formamide in the vaporizer of <20 s, based on the liquid formamide.

24. The process according to claim 21, wherein a millistructured or microstructured apparatus is used as vaporizer.

25. The process according to claim 14, wherein the reactor is a tube reactor and has an inner surface selected from among silicon-coated steel, fused silica, titanium, SiC and zirconium.

26. The process according to claim 25, wherein the thermolysis of gaseous formamide is carried out at a temperature of from 350 to 700° C.

27. The process according to claim 26, wherein the thermolysis of gaseous formamide is carried out at a pressure of from 70 mbar to 5 bar, absolute pressure.

28. The process according to claim 27, wherein the thermolysis of gaseous formamide is carried out in the presence of oxygen.

29. The process according to claim 28, wherein the gaseous formamide is obtained by vaporization of liquid formamide in a vaporizer at temperatures of from 110 to 270° C.
